(19) United States
(12) Patent Application Publication
(10) Pub. No.: US 2017/0248205 A1
(43) Pub. Date: Aug. 31, 2017

(54) IMPROVED CHAIN GUIDE AND TENSIONING APPARATUS

(71) Applicant: BorgWarner Inc., Auburn Hills, MI (US)

(72) Inventors: Alan L. MOSTER, Clarkston, MI (US); Hiroyuki FUKUYAMA, Nabari, Mie (JP); Timothy K. WHITE, Sterling Heights, MI (US)

(21) Appl. No.: 15/507,589

(22) PCT Filed: Aug. 27, 2015
(86) PCT No.: PCT/US2015/047132

§ 371 Date: Feb. 28, 2017

Related U.S. Application Data
(60) Provisional application No. 62/046,356, filed on Sep. 5, 2014.

(51) Int. Cl. F16H 7/18; F16H 7/08; F16H 57/05

(52) U.S. Cl. CPC F16H 7/18; F16H 57/05; F16H 7/08; F16H 2007/185; F16H 2007/0872; F16H 2007/0893

(57) ABSTRACT

A chain guide and tensioning apparatus (10) for reducing friction and heat generated by said chain guide and tensioning apparatus (10) engaging a driven chain (16). A guide body (12) has an engagement surface (26) and a first aperture (54) extending through the guide body (12) and opening into the engagement surface (26). A guide face (14) at least partially overlays the engagement surface (26) and has a contact surface (44) configured to guide and tension the driven chain (16). A first recessed groove (46) is formed on the contact surface (44) and is in communication with at least one second aperture (48) extending through the guide face (14). The first aperture (54) is adaptable to receive and communicate oil from an oil source to the second aperture (48) and the first recessed groove (46) for reducing friction and heat from guiding and tensioning the driven chain (16).

### FIELD OF THE INVENTION

The present invention relates to an improved chain guide and tensioning apparatus, and more particularly, a chain guide and tensioning apparatus that reduces the amount of friction and heat generated caused by the chain guide and tensioning apparatus engaging a timing chain of an automotive engine.

### BACKGROUND OF THE INVENTION

An automobile engine represents a complex interaction of mechanical parts with thermal and chemical reactions that produce the energy necessary to propel a vehicle. The most basic process within an engine is the combustion cycle. The combustion cycle is a precise interaction between the camshaft and the crankshaft that determines when the combustion cycle takes place in each cylinder of the engine block. The crankshaft and camshaft work in tandem through a connection created by a timing chain.

The timing chain is the link between the crankshaft and the camshaft that transmits the rotation of the crankshaft to the camshaft, which then causes the opening and closing of the intake and exhaust valves within an engine. The timing chain transfers energy from the crankshaft to the camshaft by wrapping around gears mounted to the ends of the two shafts, which the timing chain uses to grip the two shafts. The size of the gears creates a reduction of rotational speed that causes the camshaft to rotate at exactly one half the speed of the crankshaft.

The timing chain controls when the intake and exhaust valves open in relation to the position of the crankshaft by turning the camshaft at a precise rate. When the valves open and close is determined by the position of the camshaft in relation to the position of the crankshaft. The timing chain maintains this synchronization between the crankshaft and the camshaft, as the timing chain transmits the rotation of the crankshaft to the camshaft.

Some timing chains are mounted in a fixed position on the crankshaft and camshaft gears and cannot be adjusted. As the timing chain wears, slack in the timing chain increases and alters the valve timing of the engine. These timing chains must be replaced when excessive slack appears. Other timing chains use tensioners that maintain a consistent amount of tension within the timing chain as the chain wears, reducing the effect that the slack in the timing chain has on the valve timing of the engine. Chain guides are mounted adjacent the timing chain to guide and provide tension to the timing chain by engaging the timing chain.

In order to maintain the appropriate tension in the timing chain, both manual and automatic chain guide and tensioners have been developed. In manual chain guide and tensioners, the chain guide is manually adjusted to provide the proper amount of tension in the timing chain. In automatic chain guide and tensioners, spring tension or hydraulic pressure may be utilized to properly tension the timing chains. Such chain guide and tensioners may employ an automatically adjustable chain guide that engages and guides the timing chain. For instance, a piston tensioner may pivotally adjust the chain guide through the use of a spring-loaded or hydraulically controlled piston. By pivoting the adjustable chain guide inward against the timing chain toward the inner loop of the timing chain, the tension on the timing chain can be increased thereby compensating for the slack created by the extended use of the timing chain.

The adjustable chain guide and tensioner has a surface or guide face that engages and guides the timing chain. The guide faces of the adjustable chain guide and tensioner have been previously fabricated from various metallic materials; however, such metallic materials can create an excessive amount of noise when engaging the timing chain and may create excessive wear on the timing chain. Other designs have utilized guide faces fabricated from various polymeric materials, such as plastic, in order to reduce the amount of noise and friction created when the guide face engages the timing chain. However, such polymeric materials may be susceptible to high levels of heat generated by the timing chain engaging the guide face, wherein such high levels of heat can lead to the melting of the guide face material. Previous designs have solved this problem by developing guide faces that are fabricated from high heat resistant materials so as to prevent the melting of the guide face material. However, such high heat resistant materials are expensive thereby increasing the price of manufacturing such a guide face. The above-noted problems associated with the previous designs of the guide face of an adjustable chain guide and tensioner are undesirable in an industrial environment.

It would be desirable to create an adjustable chain guide and tensioner that provides a guide face that is inexpensive, quiet, and generates a non-destructive amount of heat when engaging a timing chain.

### SUMMARY OF THE INVENTION

A chain guide and tensioning apparatus for reducing the amount of friction and heat generated when the chain guide and tensioning apparatus engages a driven chain of an automotive engine. The chain guide and tensioning apparatus includes a guide body and a guide face. The guide body has an engagement surface and a first aperture extending through the guide body and opening into the engagement surface. The guide face at least partially overlays the engagement surface of the guide body. The guide face has a contact surface configured to guide and tension the timing chain. A first recessed grove is formed on the contact surface of the guide face. At least one second aperture extends through the guide face. The second aperture is in communication with the first recessed groove of the guide face and the first aperture of the guide body. The first aperture of the guide body is adaptable to receive and communicate oil from an oil source to the second aperture and the first recessed groove in the guide face for reducing friction and heat from the chain guide and tensioning apparatus guiding and tensioning the driven chain.

A second recessed groove may be formed in the engagement surface of the guide body. The second recessed groove is in communication with the first aperture of the guide body and the second aperture of the guide face. A plurality of recessed grooves may be formed on the contact surface of the guide face.

A second embodiment of a chain guide and tensioning apparatus for reducing the amount of friction and heat generated when the chain guide and tensioning apparatus engages a timing chain of an automotive engine includes an elongated guide body and a guide face. The elongated guide body has an engagement surface and a first aperture extending through the elongated guide body and opening into the engagement surface. The guide face is removably connected to and overlays the engagement surface of the elongated guide body. The guide face has a contact surface configured to guide and tension the driven chain. A first recessed grove is formed on the contact surface of the guide face. At least one second aperture extends through the guide face. The second aperture is in communication with the first recessed groove of the guide face and the first aperture of the elongated guide body. The first aperture of the elongated guide body is adaptable to receive and communicate oil from an oil source to the second aperture and the first recessed groove in the guide face for reducing friction and heat from the chain guide and tensioning apparatus guiding and tensioning the driven chain.

A second recessed groove may be formed in the engagement surface of the elongated guide body. The second recessed groove is in communication with the first aperture in the elongated guide body and the second aperture in the guide face. A plurality of recessed grooves may be formed in the contact surface of the guide face.

The guide face may have an underside that overlays the engagement surface of the elongated guide body. The underside and the engagement surface have a complementary configuration. The complementary configuration may include a plurality of substantially rectangular teeth and a plurality of substantially rectangular grooves. If the teeth are on the underside of the guide face, the grooves are formed in the engagement surface of the elongated guide body. If the teeth are on the engagement surface of the elongated guide body, the grooves are formed in the underside of the guide face. A gap may be formed between the teeth and grooves to allow oil to flow between the elongated guide body and the guide face.

The elongated guide body may have at least one cavity formed in the elongated guide body to reduce the weight of the elongated guide body. The guide face may have a pair of opposing, substantially parallel side walls connected to and extending outward from the contact surface of the guide face to assist with guiding the driven chain. The elongated guide body may have a pair of substantially parallel and opposing guide walls extending outward from the engagement surface of the elongated guide body to guide the driven chain. The elongated guide body may have an aperture extending through the elongated guide body on one end of the elongated guide body to allow for pivotal movement of the elongated guide body about a pivot axis. The first recessed groove of the guide face extends the entire length of the contact surface of the guide face.

A third embodiment of a chain guide and tensioning apparatus for reducing the amount of friction and heat generated when the chain guide and tensioning apparatus engages a timing chain of an automotive engine includes an elongated guide body and a guide face. The elongated guide body has an engagement surface, an underside opposing the engagement surface, a recessed groove formed in the engagement surface, and an aperture extending through the underside and opening into the recessed groove. The guide face has a contact surface configured to guide and tension the driven chain, an underside opposing the contact surface, a recessed groove formed in the contact surface, and at least one aperture extending through the underside and opening into the recessed groove. The guide face is removable connected to the elongated guide body. The underside of the guide face overlays the engagement surface of the elongated guide body.

### BRIEF DESCRIPTION OF THE DRAWINGS

The description herein makes reference to the accompanying drawings, wherein like referenced numerals refer to like parts throughout several views, and wherein:

FIG. 1 is a front plan view of the improved chain guide and tensioning apparatus of the present invention being utilized in a timing chain application;

FIG. 2 is a perspective view of the improved chain guide and tensioning apparatus of the present invention;

FIG. 3 is a perspective view of the guide face of the improved chain guide and tensioning apparatus of the present invention;

FIG. 4 is a perspective view of the guide body of the improved chain guide and tensioning apparatus of the present invention;

FIG. 5 is a bottom plan view of the guide body of the improved chain guide and tensioning apparatus of the present invention;

FIG. 6A is a top plan view showing multiple recessed grooves in the contact surface of the guide face of the improved chain guide and tensioning apparatus of the present invention;

FIG. 6B is a top plan view showing a curved recessed groove in the contact surface of the guide face of the improved chain guide and tensioning apparatus of the present invention;

FIG. 6C is a top plan view showing crossing recessed grooves in the contact surface of the guide face of the improved chain guide and tensioning apparatus of the present invention;

FIG. 6D is a top plan view showing substantially T-shaped recessed grooves in the contact surface of the guide face of the improved chain guide and tensioning apparatus of the present invention;

FIG. 6E is a top plan view showing substantially offset T-shaped recessed grooves in the contact surface of the guide face of the improved chain guide and tensioning apparatus of the present invention; and

FIG. 7 is a sectional view showing complementary engaging surfaces of the guide body and guide face of the improved chain guide and tensioning apparatus of the present invention.

### DETAILED DESCRIPTION OF THE EMBODIMENTS

Referring to the drawings, the present invention will now be described in detail with reference to the disclosed embodiments.

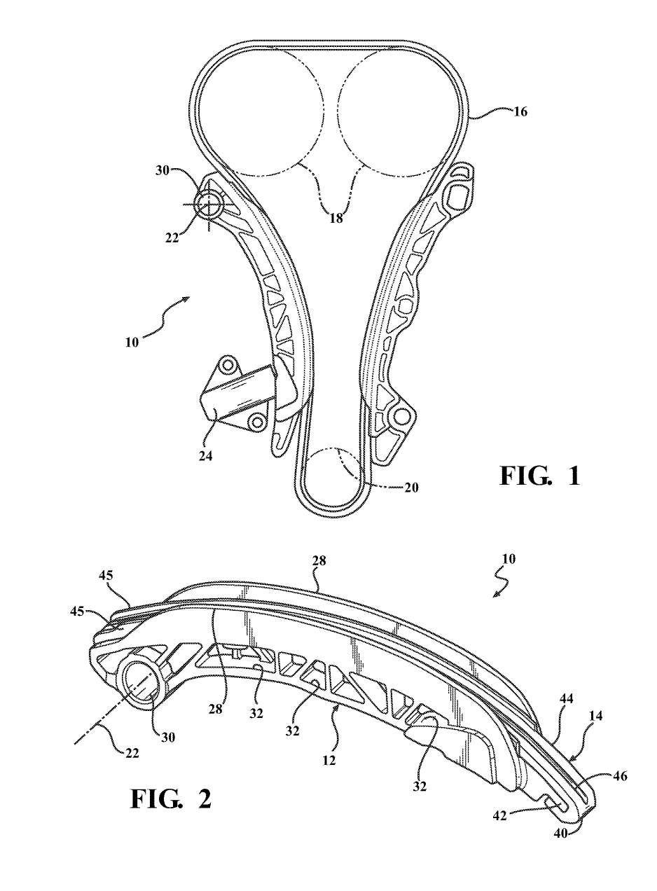

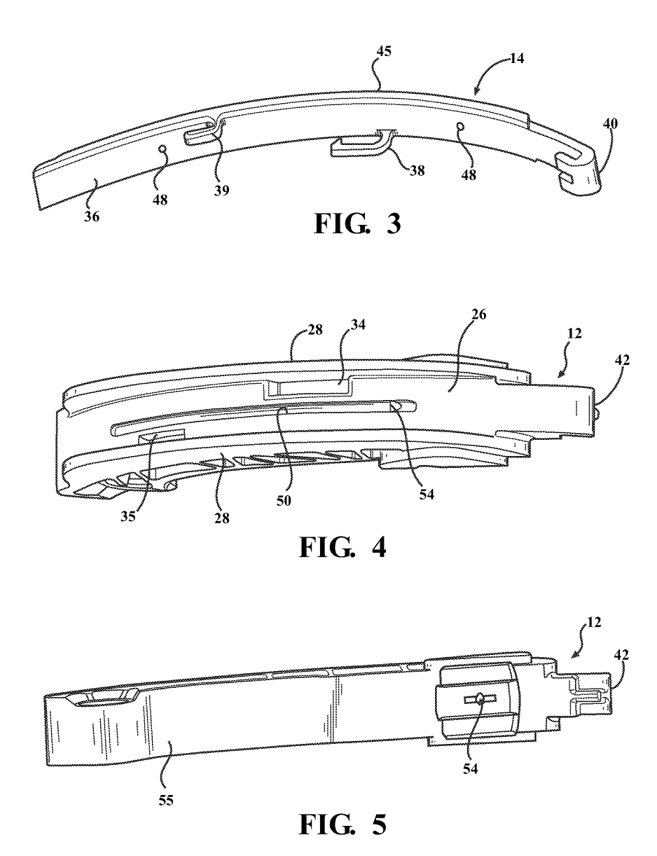

The present invention provides an improved chain guide and tensioning apparatus for reducing the amount of friction and heat that is generated when the chain guide and tensioning apparatus engages a driven chain. As seen in FIGS. 1-5, the improved chain guide and tensioning apparatus 10 provides a guide body 12 that is releasably connected to a guide face 14. The improved chain guide and tensioning apparatus 10 may be used to guide and provide tension to a driven chain, such as a timing chain 16 of an automobile engine (not shown). As seen in FIG. 1, the timing chain 16 may be used to synchronize a pair of camshafts (not shown) and a crankshaft (not shown) of an engine. In such applications, a pair of substantially circular sprockets or gears 18 are connected to the ends of the two camshafts. The sprockets or gears 18 of the camshafts are adjacent one another, and a smaller sprocket or gear 20 is connected to the end of the crankshaft opposite the sprocket or gears 18 of the camshafts. The timing chain 16 engages and is wrapped around the sprockets 18 of the camshafts and the sprocket 20 of the crankshaft. The chain guide and tensioning apparatus 10 may be pivotally mounted to a support structure (not shown), such as an engine block (not shown), between the sprockets 18 and the sprocket 20 about a pivot axis 22. A manual chain guide tensioner (not shown) or automatic chain guide tensioner, such as a piston tensioner 24, may be mounted to a support structure (not shown) adjacent the chain guide and tensioning apparatus 10, wherein the piston tensioner 24 can pivotally move the chain guide and tensioning apparatus 10 toward and away from the timing chain 16 so as to adjust the tension in the timing chain 16. As noted in the background of the invention, the proper tension in the timing chain 16 is critical to ensure for proper synchronization of the camshafts and the crankshaft. Although the chain guide and tensioning apparatus 10 of the present invention is ideally suited for the automotive timing chain application noted above, it should be noted that the present invention is not limited to such applications, but rather, the present invention may be utilized in other chain drive timing systems, balancer drives, oil pump drives, etc.

In order to properly guide and tension the timing chain 16, the guide body 12 of the chain guide and tensioning apparatus 10 may have a substantially arcuate or curvilinear configuration, wherein the outer diameter of the arcuate configuration of the guide body 12 has an engagement surface 26 that is best described as a curved planar surface, as seen in FIGS. 2 and 4. A pair of substantially parallel and opposing guide walls 28 extend outward from the engagement surface 26 of the guide body 12 so as to properly guide the timing chain 16. At one end of the guide body 12, an aperture 30 extends through the guide body 12 for receiving a pivot pin (not shown) to allow for pivotal movement of the guide body 12 about the pivot axis 22. The guide body 12 may be fabricated from a lightweight, high-strength material, such as aluminum or a glass-filled polymer. Cavities or voids 32 may be formed or molded in the guide body 12 to reduce weight and eliminate unnecessary material.

To connect the guide face 14 to the guide body 12, the engagement surface 26 of the guide body 12 provides a pair of slotted apertures 34, 35 that extend through the engagement surface 26 and into the guide body 12, wherein the slotted apertures 34, 35 are spaced, staggered, and sized differently from one another, as seen in FIGS. 2-5. The guide face 14 of the chain guide and tensioning apparatus 10 also has an arcuate or curvilinear configuration that mirrors the shape of the engagement surface 26 of the guide body 12. An underside 36 of the guide face 14 is also best described as a curved planar surface wherein the underside 36 of the guide face 14 overlays the engagement surface 26 of the guide body 12. The guide face 14 provides a pair of opposing and staggered latching teeth or hooks 38, 39 that extend integrally from the underside 36 of the guide face 14, wherein the hook 38 is larger than the other hook 39. One end 40 of the guide face 14 provides a U-shaped hooked configuration that is utilized to receive and engage an end 42 of the engagement surface 26 of the guide body 12. To connect the guide face 14 to the guide body 12 of the chain guide and tensioning apparatus 10, the end 40 of the guide face 14 receives and engages the end 42 of the engagement surface 26 of the guide body 12, and the latching teeth or hooks 38, 39 on the underside 36 of the guide face 14 are inserted into their respective slotted apertures 34, 35 provided in the engagement surface 26 of the guide body 12. The latching teeth or hooks 38, 39 of the guide face 14 engage a complementary member (not shown) within the slotted apertures 34, 35 of the guide body 12 so as to removably secure the guide face 14 to the guide body 12.

In order to properly engage and tension the timing chain 16, the guide face 14 has a contact surface 44 that extends along the outer diameter of the guide face 14 and is substantially parallel to the engagement surface 26 of the guide body 12 and the underside 36 of the guide face 14. Thus, the contact surface 44 is also best described as a curved planar surface. A pair of opposing, substantially parallel side walls 45 is integrally connected to and extends outward from the contact surface 44 of the guide face 14 to assist in guiding the timing chain 16. To reduce the noise and friction associated with the contact surface 44 of the guide face 14 engaging the timing chain 16, the guide face 14 is fabricated from a low-weight, high-strength material, such as a polymeric material or plastic. Although such materials reduce the friction and noise associated with engaging the timing chain 16, such interaction with the timing chain 16 can generate a significant amount of heat. Thus, the substantially semi-circular, recessed groove 46 extends the entire length of the contact surface 44 of the guide face 14. The recessed groove 46 in the contact surface 44 of the guide face 14 is utilized to channel oil along the contact surface 44 of the guide face 14 to reduce the amount of friction associated with the contact surface 44 contacting the timing chain 16, thereby reducing the heat generated from the engagement of the timing chain 16 by the contact surface 44 of the guide face 14.

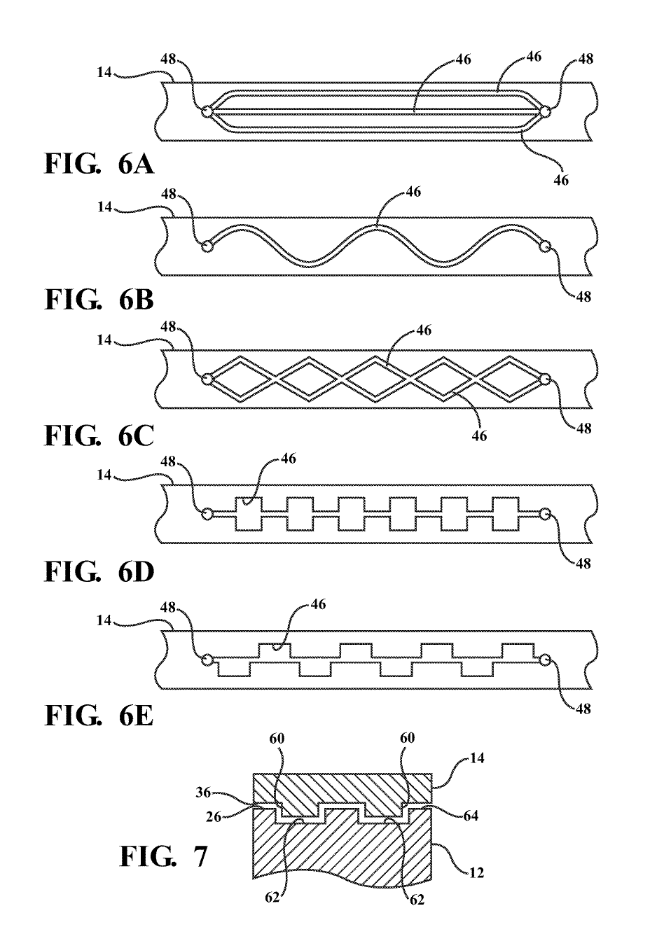

To increase the cooling efficiency of the guide face 14, various configurations of the recessed groove 46 may be provided, as shown in FIGS. 6A-6E. These configurations of the recessed groove 46 increase the amount of surface area on the contact surface 44 of the guide face 14 that is exposed to oil. Thus, in FIG. 6A, multiple recessed grooves 46 are provided and communicate with apertures 48. In FIG. 6B, a curved or worm-like configuration of the recessed groove 46 is provided and is in communication with apertures 48. In FIG. 6C, substantially straight, angled segments of the recessed groove 46 are provided wherein the segments of the recessed groove 46 cross or intersect one another and are in communication with apertures 48. In FIG. 6D, the recessed grooves 46 havee substantially T-shaped configurations and are in communication with apertures 48. Lastly, in FIG. 6E, the recessed grooves 46 have overlapping T-shaped configurations that are in communication with apertures 48.

To provide oil to the recessed groove 46 in the contact surface 44 of the guide face 14, the guide face 14 provides a pair of apertures 48, which extend through the guide face 14 by extending from the underside 36 of the guide face 14 and opening into the recessed groove 46 provided on the contact surface 44 of the guide face 14. The apertures 48 in the guide face 14 are aligned with and in communication with a substantially semi-circular, recessed groove 50 provided and formed in the engagement surface 26 of the guide body 12. An aperture 54 extends through the guide body 12 by extending through an underside 55 of the guide body 12 and opening into the recessed groove 50 provided in the engagement surface 26 of the guide body 12. Oil is supplied to the aperture 54 in the guide body 12 through an oil source, such that the oil travels to the recessed groove 50 provided in the engagement surface 26 of the guide body 12 and then travels through the apertures 48 provided in the guide face 14, wherein the oil is communicated to the recessed groove 46 provided in the contact surface 44 of the guide face 14. The oil is supplied to the aperture 54 in the guide body 12 by the piston tensioner 24, which is mounted adjacent the underside 55 of the guide body 12, wherein a piston (not shown) of the piston tensioner 24 abuts the aperture 54 on the underside 55 of the guide body 12. The piston in the piston tensioner 24 provides an aperture (not shown) in the end of the piston, and the piston tensioner 24 is filled with oil by the engine's oil pump (not shown), such that oil travels through the aperture provided in the piston and through the aperture 54 provided in the guide body 12. Oil is then transferred to the recessed groove 46 in the contact surface 44 of the guide face 14, as previously described. It should be noted that the subject application is not limited to the piston tensioner 24 being the oil source, but rather, the oil source may include a mounting boss (not shown) for supplying oil to the chain guide and tensioning apparatus 10, or the oil source may include a means for redirecting oil from the cylinder head (not shown) of the engine to the chain guide and tensioning apparatus 10.

It should be noted that the recessed groove 50 formed on the engagement surface 26 of the guide body 12 may be eliminated if so desired. In such an embodiment, the apertures 48 provided in the guide face 14 may be reduced to one aperture 48 in alignment with the aperture 54 in the guide body 12.

In order to provide an increase in the surface area between the engagement surface 26 of the guide body 12 and the underside 36 of the guide face 14, the engagement surface 26 of the guide body 12 and the underside 36 of the guide face 14 may have complementary configurations, as shown in FIG. 7. The complementary configurations may include substantially rectangular teeth 60 on the underside 36 of the guide face 14 that are received by substantially rectangular grooves 62 formed in the engagement surface 26 of the guide body 12. However, the complementary configurations may take on other shapes, such as, but not limited to, rounded teeth and grooves. A gap 64 is formed between the teeth 60 and the grooves 62 thereby allowing oil to flow between the respective surfaces. The additional amount of surface area created by the surface configurations allows for additional cooling of the guide face 14 caused by the additional contact with the oil.

Lastly, it should be noted that the present invention is not limited to the guide body 12 and guide face 14 being separate parts, but rather, the present invention anticipates that the guide body 12 and the guide face 14 could be fabricated from a single integral body (not shown) wherein oil passageways may be formed throughout the single integral body for receiving oil and cooling the guide face 14. In addition, it may be possible to add cooling fins (not shown) to the guide face 14, in either the two piece or integral body configuration, to allow oil splash cooling to occur between the guide face 14 and the guide body 12.

In operation, the chain guide and tensioning apparatus 10 of the present invention may be mounted to an engine, as shown in FIG. 1, so as to guide and provide tension to the timing chain 16 of an engine. The piston tensioner 24 engages the bottom portion of the guide body 12, thereby pivoting the chain guide and tensioning apparatus 10 toward the timing chain 16 so as to provide the proper tension in the timing chain 16. The piston tensioner 24 distributes oil through the aperture 52 provided in the guide body 12, wherein oil is transferred to the recessed groove 50 in the engagement surface 26 of the guide body 12. The oil then flows from the recessed groove 50 and the engagement surface 26 of the guide body 12 through the apertures 48 in the guide face 14, wherein oil is then directed to the recessed groove 50 provided on the contact surface 44 of the guide face 14. The oil provides the appropriate lubrication between the timing chain 16 and the contact surface 44 of the guide face 14 so as to reduce the friction and heat associated with the engagement of the timing chain 16 and the flat surface 44 of the guide face 14. By properly distributing oil to the contact surface 44 of the guide face 14 and reducing the amount of friction and heat generated by the engagement of the guide face 14 and the timing chain 16, a less expensive polymeric material can be used for the guide face 14 while still providing the appropriate properties, such as less noise and friction, associated with the engagement of the guide face 14 and the timing chain 16.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A chain guide and tensioning apparatus (10) for reducing the amount of friction and heat generated by said chain guide and tensioning apparatus (10) engaging a driven chain (16), comprising:
a guide body (12) having an engagement surface (26) and a first aperture (54) extending through said guide body (12) and opening into said engagement surface (26);
a guide face (14) at least partially overlying said engagement surface (26) of said guide body (12), and said guide face (14) having a contact surface (44) configured to guide and tension said driven chain (16); and
a first recessed groove (46) formed on said contact surface (44) of said guide face (14), wherein at least one second aperture (48) extends through said guide face (14) and is in communication with said first recessed groove (46) of said guide face (14) and said first aperture (54) of said guide body (12),
wherein said first aperture (54) of said guide body (12) adaptable to receive and communicate oil from an oil source to said at least one second aperture (48) and said first recessed groove (46) in said guide face (14) for reducing friction and heat from said chain guide and tensioning apparatus (10) guiding and tensioning said driven chain (16).

2. The chain guide and tensioning apparatus (10) stated in claim 1, further comprising:
a second recessed groove (50) formed in said engagement surface (26) of said guide body (12), wherein said second recessed groove (50) is in communication with said first aperture (54) of said guide body (12) and said at least one second aperture (48) of said guide face (14).

3. The chain guide and tensioning apparatus (10) stated in claim 1, wherein said first recessed groove (46) further comprises:
a plurality of recessed grooves (46) formed on said contact surface (44) of said guide face (14).

4. A chain guide and tensioning apparatus (10) for reducing the amount of friction and heat generated by said chain guide and tensioning apparatus (10) engaging a driven chain (16), comprising:
an elongated guide body (12) having an engagement surface (26) and a first aperture (54) extending through said elongated guide body (12) and opening into said engagement surface (26);
a guide face (14) removably connected to and overlying said engagement surface (26) of said elongated guide body (12), and said guide face (14) having a contact surface (44) configured to guide and tension said driven chain (16); and
a first recessed groove (46) formed on said contact surface (44) of said guide face (14), wherein at least one second aperture (48) extends through said guide face (14) and is in communication with said first recessed groove (46) of said guide face (14) and said first aperture (54) of said elongated guide body (12),
wherein said first aperture (54) of said elongated guide body (12) is adaptable to receive and communicate oil from an oil source to at least one second aperture (48) and said first recessed groove (46) in said guide face (14) for reducing friction and heat from said chain guide and tensioning apparatus (10) guiding and tensioning said driven chain (16).

5. The chain guide and tensioning apparatus (10) stated in claim 4, further comprising:
a second recessed groove (50) formed in said engagement surface (26) of said elongated guide body (12), wherein said second recessed groove (50) is in communication with said first aperture (54) of said elongated guide body (12) and said at least one second aperture (48) of said guide face (14).

6. The chain guide and tensioning apparatus (10) stated in claim 4, wherein said first recessed groove (46) further comprises:
a plurality of recessed grooves (46) formed on said contact surface (44) of said guide face (14).

7. The chain guide and tensioning apparatus (10) stated in claim 4 further comprising:
said guide face (14) having an underside (36) overlying said engagement surface (26) of said elongated guide body (12), wherein said underside (36) and said engagement surface (26) have a complementary configuration.

8. The chain guide and tensioning apparatus (10) stated in claim 7, wherein said complementary configuration further comprises:
a plurality of substantially rectangular teeth (60) on one of either said underside (36) of said guide face (14) or said engagement surface (26) of said elongated guide body (12); and
a plurality of substantially rectangular grooves (62) formed in the other of said underside (36) of said guide face (14) or said engagement surface (26) of said elongated guide body (12).

9. The chain guide and tensioning apparatus (10) stated in claim 8, wherein said complementary configuration further comprises:
a gap (64) formed between the plurality of substantially rectangular teeth (60) and the plurality of substantially rectangular grooves (62) to allow oil to flow between said elongated guide body (12) and said guide face (14).

10. The chain guide and tensioning apparatus (10) stated in claim 4 further comprising:
said elongated guide body (12) having at least one cavity (32) formed in said elongated guide body (12) to reduce the weight of said elongated guide body (12).

11. The chain guide and tensioning apparatus (10) stated in claim 4 further comprising:
said guide face (14) having a pair of opposing, substantially parallel side walls (45) connected to and extending outward from said contact surface (44) of said guide face (14) to assist in guiding said driven chain (16).

12. The chain guide and tensioning apparatus (10) stated in claim 4 further comprising:
said elongated guide body (12) having a pair of substantially parallel and opposing guide walls (28) extending outward from said engagement surface (26) of said elongated guide body (12) to guide said driven chain (16).

13. The chain guide and tensioning apparatus (10) stated in claim 4 further comprising:
said elongated guide body (12) having an aperture (30) extending through said elongated guide body (12) on one end of said elongated guide body (12) to allow for pivotal movement of said elongated guide body (12) about a pivot axis (22).

14. The chain guide and tensioning apparatus (10) stated in claim 4, wherein said first recessed groove (46) of said guide face (14) extends the entire length of said contact surface (44) of said guide face (14).

15. A chain guide and tensioning apparatus (10) for reducing the amount of friction and heat generated by said chain guide and tensioning apparatus (10) engaging a driven chain (16), comprising:
an elongated guide body (12) having an engagement surface (26), an underside (55) opposing said engagement surface (26), a recessed groove (50) formed in said engagement surface (26), and an aperture (54) extending through said underside (55) and opening into said recessed groove (50);
a guide face (14) having a contact surface (44) configured to guide and tension said driven chain (16), an underside (36) opposing said contact surface (44), a recessed groove (46) formed in said contact surface (44), and at least one aperture (48) extending through said underside (36) and opening into said recessed groove (46),
wherein said guide face (14) is removably connected to said elongated guide body (12), said underside (36) of said guide face (14) overlying said engagement surface (26) of said elongated guide body (12).
